(19) United States
(12) Patent Application Publication
(10) Pub. No.: US 2002/0045548 A1
(43) Pub. Date: Apr. 18, 2002

(54) Heat-sensitive recording sheet

(76) Inventor: Toranosuke Saito, Osaka (JP)

Correspondence Address: Ronald R. Santucci, Pitney, Hardin, Kipp & Szuch LLP, 711 Third Avenue, New York, NY, 10017, US

(21) Appl. No.: 09/848,146

(22) Filed: May 3, 2001

(30) Foreign Application Priority Data
Aug. 23, 2000 (JP) 2000-252477

(51) Int. Cl. B41M 5/24

(52) U.S. Cl. 503/209; 503/216; 503/225

(57) ABSTRACT

A heat-sensitive recording sheet comprises an electron donative leuco dye, an acidic developer for developing the dye, and a sensitizer. The acidic developer has a main component of a phenolic compound that contains a sulfonyl group in a molecule. The sensitizer comprises an amide compound, N-(4-tolyl) -phenylacetic amide. An amide compound to be mixed with the N-(4-tolyl)-phenylacetic amide for use in the sensitizer is at least one compound selected from the group consisting of N -cyclohexylphenylacetic amide, N-phenylphenylacetic amide, N-(2-tolyl)phenylacetic amide, N-phenylphenoxyacetic amide, N-(4-tolyl)phenoxyacetic amide, N-phenyl-(4-tolyloxy)acetic amide and N-(4-tolyl)-(4-tolyloxy)acetic amide.

### BACKGROUND OF THE INVENTION

1. Field of the Invention

The present invention relates to a heat-sensitive recording sheet, and more particularly to a heat-sensitive recording sheet that utilizes a developing reaction between an electron donative leuco dye and an acidic developer for developing the dye.

2. The Prior Art

Crystal violet lactone (blue developing) and 2-anilino-3-methyl-6-dibutylaminofluoran (black developing) represent an electron donative leuco dye (a dye precursor), which causes a developing reaction with an electron acceptive or acidic developer represented by a phenolic compound and a nuclear-substituted zinc salicylate. This developing reaction is utilized in recording sheets that are known as pressure-sensitive recording sheets and heat-sensitive recording sheets, both of which are widely employed.

In the heat-sensitive recording sheet, a crystalline electron donative leuco dye and crystalline acidic developer are present in a recording layer, closing to each other. When heated by a thermal pen or thermal head, they are melted and mixed, reacting with each other to produce a developed record image. The developing principle and recording mechanism have also been known already. For the purpose of improving a recording speed, it is also known that a third substance with a relatively lower melting point, called a sensitizer, is commonly added in order to reduce an amount of thermal energy applied on the heat-sensitive recording sheet for obtaining records.

Preferably, for this purpose, the sensitizer can melt at a relatively lower melting point to fast dissolve the leuco dye or the developer.

Sensitizers used in the art have melting points ranging between 90-110° C., preferably 95-105° C. The sensitizer for use in a heat-sensitive recording sheet has an effect more than simply improving the recording speed of the heat-sensitive recording sheet. It also has another effect, which should not be overlooked, to prevent adhesive substances from adhering on the thermal pen or head, which can be often observed in heat-sensitive recording sheets that employ only the leuco dye and developer without any sensitizer. Therefore, preferably, the sensitizer has a small melt viscosity and serves as a lubricant once cooled.

Known and practically employed sensitizers in the art, corresponding to the widely used developers, include stearoyl amide, 1,2-diphenoxyethane, 1,2-di(3-tolyloxy)ethane, 2-benzyloxynaphthalene, 4-benzylbiphenyl, di(4-methylbenzyl) oxalate and 4-(4-tolyloxy)biphenyl. These technologies are detailed in JP 58-87094A, JP 59-9092A, JP 60-56588A, JP 60-82382A, JP 64-1583A, JP 02-9683A and JP 03-36034A publications.

Known and practically employed acidic developers mainly include phenolic compounds such as 4,4′-isopropylidene diphenol (bisphenol-A), 4,4′-secondary butylidenediphenol, 2,2-bis(4-hydroxyphenyl)-4-methylpentane, 2,2′-dihydroxy biphenyl and 4-hydroxybenzyl benzoate. These technologies are detailed in JP 45-14039B, JP 51-29830B and JP 03-54071B publications.

When the electron donative leuco dye and acidic developer are heated and melted together to obtain a developed record image, the presence of the developer makes it possible to reduce necessary energy to be applied and achieve a high-speed recording. Because of excellent retentiveness of records, a phenolic compound that contains a sulfonyl group in a molecule, such as 4,4′-dihydroxydiphenylsulfon, 4-hydroxy-4′-isopropoxydiphenylsulfon and 2, 4-di(phenylsulfonyl) -5-methyl phenol, has been recently employed as a new developer. In the background of such the variation, there was a disadvantage that the conventional sensitizers can not fully draw good characteristics out of the new developers. The disadvantage is especially remarkable when 4,4′-dihydroxydiphenylsulfon is employed as the developer. Disadvantages of the conventional sensitizers, against the new developer that has a main component of the sulfonyl group-containing phenolic compound, are listed below:

1. Low Developing Sensitivity

The conventional sensitizer generally has a low melting action with the new developer and often can not melt the developer fully at a temperature near the melting point of the sensitizer. Therefore, it requires a much higher temperature for developing reaction. This generally means that a developing sensitivity is low.

2. Reduction of Record Retentiveness

With respect to the new developer, the conventional sensitizer tends to reduce the record retentiveness, compared with the case that the same developing is performed without the sensitizer and just with a full heating. The record retentiveness defines a resistance against the fading of printings when records are retained for a long time at a relatively higher temperature, when records are retained in contact with a film and the like that contains a plasticizer, when records are retained under a high humidity, and when records contaminated with oils and fats such as a hand cream are retained. In particular, the fading of printings is remarkable when records are retained in contact with the film that contains a plasticizer, and normally, this anti-plasticizer property represents the record retentiveness.

3. Influence From Volatility of Sensitizer

The conventional sensitizer generally has a small molecular weight and a high sensitizing effect while it has more or less volatility. If a sensitizer with a large volatility is employed, however, it is known to rise a few influences. For example, volatilization and dissipation of the sensitizer reduces the developing sensitivity of the recording sheet to be used after a long-term retention. In addition, when the recording sheet is employed in a facsimile and the like, the sensitizer volatilized by the thermal head-heating solidifies and precipitates on a cooled part directly behind the thermal head to cause a trouble called a head residue. Finally, when the recording sheet has an adhesive layer on the rear surface of the recording sheet, a sensitizer on the front surface is volatilized and transferred through a gap between fibers of the paper to the adhesive layer to reduce the adhesive force thereof.

4. Powdering Phenomenon of Sensitizer

A powdering phenomenon of the sensitizer, also called whitening or blooming, is a phenomenon that white powders appear when microcrystals consisting mainly of the sensitizer crystallizes on the printing surface of records that is obtained once heated and melted. This can be seen like a white powder bloom and reduces an apparent density of printings. Therefore, the use of such the sensitizer should be avoided. In general, this phenomenon appears several hours through several days after printing. The powdering phenomenon is difficult to be predicted from the molecular structure of the sensitizer. The only effective way is to repeat synthesis and evaluation on compounds one by one. Thus, it is not easy to find out a sensitizer that is applicable to the new developer without the powdering phenomenon and can be employed solely.

### SUMMARY OF THE INVENTION

An object of the present invention is to provide a heat-sensitive recording sheet without the above disadvantages, especially the “powdering phenomenon”, through the use of a new developer consisting of a phenolic compound that contains a sulfonyl group in a molecule, along with a sensitizer and sensitizer mixture newly found to correspond to the new developer.

Accordingly, the present invention provides a heat-sensitive recording sheet which comprises an electron donative leuco dye, an acidic developer for developing the dye, and a sensitizer, wherein the acidic developer has a main component of a phenolic compound containing a sulfonyl group in a molecule, and the sensitizer contains an amide compound, N-(4-tolyl) -phenylacetic amide.

The present invention also provides a heat-sensitive recording sheet which comprises an electron donative leuco dye, an acidic developer for developing the dye, and a sensitizer, wherein the acidic developer has a main component of a phenolic compound containing a sulfonyl group in a molecule, and the sensitizer contains a mixture of at least two amide compounds selected from the group consisting of N-cyclohexylphenylacetic amide, N-phenylphenylacetic amide, N-(2-tolyl)phenylacetic amide, N-(4-tolyl)phenylacetic amide, N-phenylphenoxyacetic amide, N-(4-tolyl)phenoxyacetic amide, N-phenyl-(4-tolyloxy) acetic amide, and N-(4-tolyl)-(4-tolyloxy)acetic amide.

The present invention further provides a heat-sensitive recording sheet which comprises an electron donative leuco dye, an acidic developer for developing the dye, and a sensitizer, wherein the acidic developer has a main component of a phenolic compound containing a sulfonyl group in a molecule, and the sensitizer contains a mixture of at least one amide compound selected from the group consisting of N-cyclohexylphenylacetic amide, N-phenylphenylacetic amide, N-(2-tolyl)phenylacetic amide, N-(4-tolyl)phenylacetic amide, N-phenylphenoxyacetic amide, N-(4-tolyl)phenoxyacetic amide, N-phenyl-(4-tolyloxy) acetic amide, and N-(4-tolyl)-(4-tolyloxy)acetic amide with at least one ether or ester compound selected from the group consisting of 1,2-diphenoxyethane, 1,2-di(3-tolyloxy)ethane, 2-benzyloxynaphthalene, and di(4-methyl benzyl)oxalate.

### MODES OF EMBODIMENT OF THE INVENTION

In a heat-sensitive recording sheet according to the present invention, an acidic developer has a main component of a phenolic compound that contains a sulfonyl group in a molecule, and a sensitizer comprises an amide compound, N-(4-tolyl) -phenylacetic amide, or its mixture in combination with other amide compounds, thereby fully solving the subject of the present invention.

The acidic developer for use in the present invention has a main component of a phenolic compound that contains a sulfonyl group in a molecule. Therefore, it is advantageous to obtain a heat-sensitive recording sheet that is more excellent in record retentiveness compared to those by developers consisting of other phenolic compounds.

Specific examples include 2,4′-dihydroxydiphenylsulfon, 4,4′-dihydroxydiphenylsulfon, 3,3′-dimethyl-4,4′-dihydroxy diphenylsulfon, 3,3′-diaryl-4,4′-dihydroxydiphenylsulfon, 3,3′-diphenyl-4,4′-dihydroxydiphenylsulfon, 4-hydroxy-4′-isopropoxydiphenylsulfon, 1,5-(3-oxapentene)bis-4-(4-hydroxyphenylsulfonyl)phenoxide, α,α-(1,3-xylilene)bis-4(4-hydroxyphenylsulfonyl)phenoxide, 2,4-diphenylsulfonyl phenol and 2,4-diphenylsulfonyl-5-methylphenol, more preferably 4,4′-dihydroxydiphenylsulfon, 4-hydroxy-4′-isopropoxydiphenylsulfon and 2,4-diphenylsulfonyl-5-methyl phenol, and most preferably 4,4′-dihydroxydiphenylsulfon.

The sensitizer for use in the present invention solely or in combination with other sensitizer is N-(4-tolyl) -phenylacetic amide. This is a white crystal having a molecular weight of 225 and amelting point of 134-135° C. and is represented by the following structural formula (1):

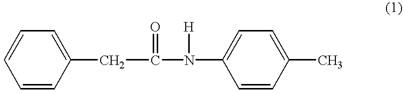

This is the only one compound found in the process of completing the present invention as a sensitizer solely useable with a developer that has a main component of a phenolic compound containing a sulfonyl group in a molecule. This only one compound was found after many analogous compounds were synthesized and examined. In particular, it was not easy to find a sensitizer that can be employed solely without the powdering phenomenon of recorded printings. Such analogous compounds that satisfy all properties except for the powdering phenomenon are abandoned to use as sensitizers solely in the present invention only because of that defect. They include N -cyclohexylphenylacetic amide (melting point: 139° C.), N -phenylphenylacetic amide (melting point: 118° C.), N-(2-tolyl) phenylacetic amide (melting point: 162° C.), N-(3-tolyl) phenylacetic amide (melting point: 90° C.), N-benzylphenyl acetic amide (melting point: 124° C.), N-cyclohexylphenoxy acetic amide (melting point: 91° C.), N-phenylphenoxyacetic amide (melting point: 102° C.), N-(4-tolyl)phenoxyacetic amide (melting point: 105° C.), N-phenyl-(4-tolyloxy)acetic amide (melting point: 110° C.) and N-phenyl-(4-tolyl)-(4-tolyloxy)acetic amide (melting point: 115° C.). Surprisingly, only the N-(4-tolyl)phenylacetic amide among those was found to have an applicability in all properties with the developer that has a main component of a phenolic compound containing a sulfonyl group in a molecule.

It is found, however, that even though the amide compounds are determined to exhibit the powdering phenomenon, they can prevent the powdering phenomenon when they employ the N-(4-tolyl)phenylacetic amide in combination. There are several amide compounds that can be mixed with the N-(4-tolyl)phenylacetic amide and employed in the heat-sensitive recording sheet of the present invention to prevent the powdering phenomenon. They include N-cyclohexylphenylacetic amide, N-phenylphenylacetic amide, N-(2-tolyl)phenylacetic amide, N-phenylphenoxyacetic amide, N-(4-tolyl)phenoxyacetic amide, N-phenyl-(4-tolyloxy)acetic amide and N-(4-tolyl) -(4-tolyloxy)acetic amide. Preferably, in their mixing ratios, the N-(4-tolyl) phenylacetic amide is present in a range of 30-80% by weight.

More surprisingly, even though sensitizers exhibit the powdering phenomenon when they are employed solely, the sensitizers can prevent the powdering phenomenon when they are employed in combination with any two or more sensitizers. It is preferable to employ such a mixing ratio that contains a large amount of a low melting point amide compound and a small amount of a high melting point amide compound. Three or more amide compounds may also be mixed to obtain a good result in preventing the powdering phenomenon.

The heat-sensitive sensitizer with a melting point of 135° C., N-(4-tolyl)phenylacetic amide, has a relatively higher melting point. A heat-sensitive recording sheet, which employs this sensitizer solely, has an advantage because it hardly causes a surface stain when it is exposed at a high temperature (80-100° C.) (non-contamination by heat). Though, the heat-sensitive recording sheet has a disadvantage because it has a degraded developing sensitivity (recording speed) compared to a heat-sensitive recording sheet having a mixture of another developer and another low melting point sensitizer. The above advantage and disadvantage are such properties that stand on opposite balances. Therefore, the developing sensitivity (recording speed) can be improved when a further low melting point sensitizer is added to the sensitizer according to the present invention. It is an effect of the method according to the present invention and is not found in the conventional method to further employ another low melting point sensitizer for adjusting the balance of the non-contamination from heat with the recording speed.

Other low melting point sensitizers for use in the present invention include stearoyl amide, 1,2-diphenoxyethane, 1,2-di(3-tolyloxy)ethane, 2-benzyloxynaphthalene, 4-benzyl biphenyl, di(4-methylbenzyl)oxalate and 4-(4-tolyloxy) biphenyl, more preferably 1,2-diphenoxyethane (melting point: 97° C.), 1,2-di(3-tolyloxy)ethane (melting point: 98 ° C.), 2-benzyloxynaphthalene (melting point: 102° C.) and di(4-methylbenzyl)oxalate (melting point: 105° C.). These low melting point sensitizers can be employed in combination with the sensitizer of the present invention at 70% or below by weight of the sensitizer of the present invention.

In addition, again surprisingly, the powdering phenomenon can also be prevented when the sensitizer employs a mixture of at least one selected from the group consisting of N-cyclohexylphenylacetic amide, N-phenylphenylacetic amide, N-(2-tolyl)phenylacetic amide, N-(4-tolyl)phenylacetic amide, N-phenylphenoxyacetic amide, N-(4-tolyl)phenoxyacetic amide, N-phenyl-(4-tolyloxy)acetic amide and N-(4-tolyl)-(4-tolyloxy)acetic amide, and mixed with at least one selected from the group consisting of 1,2-diphenoxy ethane, 1,2-di(3-tolyloxy)ethane, 2-benzyloxynaphthalene and di(4-methylbenzyl)oxalate. Preferably, a mixing ratio of the low melting point sensitizer to the amide compound is similarly equal to 70% by weight or less.

The electron donative leuco dyes for use in the present invention include crystal violet lactone, 3,3-bis(4-dimethyl aminophenyl)phthalide, 3-(4-dimethylaminophenyl)-3-(1,2-dimethylaminoindole-3-yl)phthalide, 2-anilino-3-methyl-6-diethylaminofluoran, 2-anilino-3-methyl-6-(methylcyclohexyl amino)fluoran, 2-anilino-3-methyl-6-(ethylisopentylamino) fluoran, 2-anilino-3-methyl-6-dibutylaminofluoran, 2-(4-chloroanilino)-3-methyl-6-diethylaminofluoran, 2-(4-fluoro anilino)-3-methyl-6-dibutylaminofluoran, 2-anilino-3-methyl -6-(4-toluidinoethylamino)fluoran, 2-(2-chloroanilino)-6-dibutylaminofluoran, 2-(2-fluoroanilino)-6-diethylamino fluoran, 2-(2-fluoroanilino)-6-dibutylaminofluoran, 2-anilino-3-methyl-6-piperidinofluoran, 2-(3-trifluoromethyl anilino)-6-diethylaminofluoran, 2-(2-ethoxyethylamino)-3-chloro-6-diethylaminofluoran, 2-anilino-3-chloro-6-diethyl aminofluoran, 2-chloro-3-methyl-6-dimethylaminofluoran, 3-methyl-3-spirodinaphthopyran, 3-methylnaphtho(3-methoxy benzo)spiroran, 1,3,3-trimethyl-6′-nitro-8′-methoxyspiro (indoline-2,2′-benzopyran) and 1,3,3-trimethyl-6′-nitrospiro (indoline-2,2′-benzopyran). In addition, all currently known electron donative leuco dyes for heat-sensitive recording sheet can be employed.

For the purpose of further improving the record retentiveness, polyvalent phenolic compounds, epoxy compounds, metal salts of organic carboxylic acids, and metal salts of organic phosphorous compounds may be employed. All of them may also be applied to the heat-sensitive recording sheet of the present invention.

Leuco dyes, developers, sensitizers and other additives for use in heat-sensitive recording sheets are usually pulverized in water that contains a dispersing agent using media such as a ball mill and a sand grinder, and mixed. Then, a filler such as calcium carbonate and silicic acid anhydride, a lubricant such as waxes, an aqueous adhesive and a defoaming agent are added and mixed to prepare a paint for the heat-sensitive recording sheet. This paint is normally coated on a surface of a support such as paper or film and dried to finish the heat-sensitive recording sheet. A super calendering process may often be performed to smooth the surface.

The developer for use in the present invention, having a main component of the phenolic compound that contains a sulfonyl group in a molecule, is preferable to have a content of 0.5-4.0 g/m², more preferably 1.0-2.0 g/m². The sensitizer for use in the present invention, consisting of amide compounds such as N-(4-tolyl)phenylacetic amide and other low melting point sensitizers, is preferable to have a total content of 0.5-4.0 g/m², more preferably 1.0-2.0 g/m².

### EXAMPLES

The present invention will be more fully understood from the following description with reference to specific examples and comparative examples. In the examples, the term “parts” is employed to denote weight parts. The examples of the present invention and the comparative examples are employed for the purpose of comparing with each other and thus their paint compositions are intentionally approximated. Therefore, the following examples are not intended to limit the present invention.

### Example 1

<Preparation of A-solution>

| | | |
|---|---|---|
| 2-anilino-3-methyl-6-dibutylaminofluoran: | 15 | parts |
| N-(4-tolyl)phenylacetic amide: | 25 | parts |
| Aqueous solution of 5 wt. % methyl cellulose: | 15 | parts |
| Water: | 120 | parts |

This composition was pulverized with a sand grinder to an average diameter of 1 μm to obtain A-solution.

<Preparation of B-solution>

| | |
|---|---|
| 4,4′-dihydroxydiphenylsulfon: | 30 parts |
| Aqueous solution of 5 wt. % methyl cellulose: | 30 parts |
| Water: | 70 parts |

This composition was pulverized with a sand grinder to an average diameter of 1 μm to obtain B-solution.

<Preparation of Heat-sensitive Recording Sheet>

175 parts of A-solution, 130 parts of B-solution, 30 parts of calcium carbonate pigment, 150 parts of aqueous solution of 20 wt. % oxidized starch and 55 parts of water were mixed to prepare a paint. The obtained paint was applied on a sheet of original paper and dried to prepare a heat-sensitive recording sheet so that an applied amount of the paint after dried becomes 7.5 g/m² an amount of 4,4′-dihydroxydiphenylsulfon: 1.70 g/m²; an amount of N-(4-tolyl)phenylacetic amide: 1.42 g/m²}. The obtained heat-sensitive recording sheet was finished through the super calendering process for the purpose of retaining the smoothness of the surface.

### Example 2

A heat-sensitive recording sheet was finished in the same manner as Example 1 except for employing 4-hydroxy-4′-isopropoxydiphenylsulfon instead of 4,4′-dihydroxydiphenyl sulfon used in Example 1.

### Example 3

A heat-sensitive recording sheet was finished in the same manner as Example 1 except for employing 2,4-diphenylsulfonyl-5-methylphenol instead of 4,4′-dihydroxydiphenylsulfon used in Example 1.

### Example 4

A heat-sensitive recording sheet was finished in the same manner as Example 1 except for altering only the A-solution prepared in Example 1 to have the following composition.

| | | |
|---|---|---|
| 2-anilino-3-methyl-6-dibutylaminofluoran: | 15 | parts |
| N-(4-tolyl)phenylacetic amide: | 20 | parts |
| 1,2-diphenoxyethane: | 10 | parts |
| Aqueous solution of 5 wt. % methyl cellulose: | 15 | parts |
| Water: | 120 | parts |

The heat-sensitive recording sheet includes 1.64 g/m² of 4,4′-dihydroxydiphenylsulfon, 1.10 g/m² of N-(4-tolyl) phenylacetic amide and 0.55 g/m² of 1,2-diphenoxyethane.

### Example 5

A heat-sensitive recording sheet was finished in the same manner as Example 4 except for employing 1,2-di(3-tolyloxy) ethane instead of 1,2-diphenoxyethane used in Example 4.

### Example 6

A heat-sensitive recording sheet was finished in the same manner as Example 4 except for employing 2-benzyloxynaphthalene instead of 1,2-diphenoxyethane used in Example 4.

### Example 7

A heat-sensitive recording sheet was finished in the same manner as Example 4 except for employing di(4-methylbenzyl) oxalate instead of 1,2-diphenoxyethane used in Example 4.

### Example 8

A heat-sensitive recording sheet was finished in the same manner as Example 4 except for employing 4-hydroxy-4′-isopropoxydiphenylsulfon instead of 4,4′-dihydroxydiphenyl sulfon used in Example 4.

### Example 9

A heat-sensitive recording sheet was finished in the same manner as Example 8 except for employing 1,2-di(3-tolyloxy) ethane instead of 1,2-diphenoxyethane used in Example 8.

### Example 10

A heat-sensitive recording sheet was finished in the same manner as Example 4 except for employing 2,4-diphenylsulfonyl5-methylphenol instead of 4,4′-dihydroxydiphenylsulfon used in Example 4.

### Example 11

A heat-sensitive recording sheet was finished in the same manner as Example 10 except for employing 1,2-di(3-tolyloxy) ethane instead of 1,2-diphenoxyethane used in Example 10.

### Example 12

A heat-sensitive recording sheet was finished in the same manner as Example 1 except for altering only the A-solution prepared in Example 1 to have the following composition.

| | | |
|---|---|---|
| 2-anilino-3-methyl-6-dibutylaminofluoran: | 15 | parts |
| N-(4-tolyl)phenylacetic amide: | 20 | parts |
| N-cyclohexylphenylacetic amide: | 10 | parts |
| Aqueous solution of 5 wt. % methyl cellulose: | 15 | parts |
| Water: | 120 | parts |

The heat-sensitive recording sheet includes 1.64 g/m² of 4,4′-dihydroxydiphenylsulfon, 1.10 g/m² of N-(4-tolyl) phenylacetic amide and 0.55 g/m² of N-cyclohexylphenylacetic amide.

### Example 13

A heat-sensitive recording sheet was finished in the same manner as Example 12 except for employing N-phenylphenylacetic amide instead of N-cyclohexylphenylacetic amide used in Example 12.

### Example 14

A heat-sensitive recording sheet was finished in the same manner as Example 12 except for employing N-(2-tolyl) phenylacetic amide instead of N-cyclohexylphenylacetic amide used in Example 12.

### Example 15

A heat-sensitive recording sheet was finished in the same manner as Example 12 except for employing N-(4-tolyl) phenoxyacetic amide instead of N-cyclohexylphenylacetic amide used in Example 12.

### Example 16

A heat-sensitive recording sheet was finished in the same manner as Example 1 except for altering only the A-solution prepared in Example 1 to have the following composition:

| | | |
|---|---|---|
| 2-anilino-3-methyl-6-dibutylaminofluoran: | 15 | parts |
| N-phenylphenylacetic amide: | 10 | parts |
| N-phenylphenoxyacetic amide: | 10 | parts |
| N-(4-tolyl)phenoxyacetic amide: | 10 | parts |
| Aqueous solution of 5 wt. % methyl cellulose: | 15 | parts |
| Water: | 120 | parts |

The heat-sensitive recording sheet includes 1.64 g/m² of 4,4′-dihydroxydiphenylsulfon, 0.55 g/m² of N-phenylphenylacetic amide, 0.55 g/m² of N-phenylphenoxyacetic amide and 0.55 g/m² of N-(4-tolyl)phenoxyacetic amide.

### Example 17

A heat-sensitive recording sheet was finished in the same manner as Example 1 except for altering only the A-solution prepared in Example 1 to have the following composition.

| | | |
|---|---|---|
| 2-anilino-3-methyl-6-dibutylaminofluoran: | 15 | parts |
| N-phenylphenylacetic amide: | 15 | parts |
| 1,2-diphenoxyethane: | 15 | parts |
| Aqueous solution of 5 wt. % methyl cellulose: | 15 | parts |
| Water: | 120 | parts |

The heat-sensitive recording sheet includes 1.64 g/m² of 4,4′-dihydroxydiphenylsulf on, 0.82 g/m² of N-phenylphenylacetic amide and 0.82 g/m² of 1,2-diphenoxyethane.

### Example 18

A heat-sensitive recording sheet was finished in the same manner as Example 17 except for employing N-phenylphenoxyacetic amide instead of N-phenylphenylacetic amide used in Example 17.

### Comparative Example 1

A heat-sensitive recording sheet was finished in the same manner as Example 1 except for employing 2,2′-diphenoxyethane instead of N-(4-tolyl)phenylacetic amide used in Example 1.

### Comparative Example 2

A heat-sensitive recording sheet was finished in the same manner as Example 1 except for employing 2,2′-di(3-tolyloxy) xyethane instead of N-(4-tolyl)phenylacetic amide used in Example 1.

### Comparative Example 3

A heat-sensitive recording sheet was finished in the same manner as Example 1 except for employing 2-benzyloxynaphthalene instead of N-(4-tolyl)phenylacetic amide used in Example 1.

### Comparative Example 4

A heat-sensitive recording sheet was finished in the same manner as Example 1 except for employing di(4-methylbenzyl) oxalate instead of N-(4-tolyl)phenylacetic amide used in Example 1.

### Comparative Example 5

A heat-sensitive recording sheet was finished in the same manner as Example 1 except for employing N-cyclohexylphenyl acetic amide instead of N-(4-tolyl)phenylacetic amide used in Example 1.

### Comparative Examples 6-14

Heat-sensitive recording sheets were finished in the same manner as Comparative example 5 except for employing in turn N-phenyl phenylacetic amide (COMPARATIVE EXAMPLE 6), N-(2-tolyl) phenylacetic amide (COMPARATIVE EXAMPLE 7), N-(3-tolyl) phenylacetic amide (COMPARATIVE EXAMPLE 8), N-benzylphenyl acetic amide (COMPARATIVE EXAMPLE 9), N-cyclohexylphenoxy acetic amide (COMPARATIVE EXAMPLE 10), N-phenylphenoxyacetic amide (COMPARATIVE EXAMPLE 11), N-(4-tolyl)phenoxyacetic amide (COMPARATIVE EXAMPLE 12), N-phenyl-(4-tolyloxy)acetic amide (COMPARATIVE EXAMPLE 13) and N-(4-tolyl)-(4-lyloxy) acetic amide (COMPARATIVE EXAMPLE 14) instead of N -cyclohexylphenylacetic amide used in Comparative example 5.

### Comparative Example 15

A heat-sensitive recording sheet was finished in the same manner as Example 1 except for employing N-(4-tolyl)acetic amide instead of N-(4-tolyl)phenoxyacetic amide used in Example 1

### Comparative Example 16

A heat-sensitive recording sheet was finished in the same manner as Example 1 except for employing 4,4′-isopropylidene diphenol instead of 4,4′-dihydroxydiphenylsulfon used in Example 1.

### Comparative Example 17

A heat-sensitive recording sheet was finished in the same manner as Comparative example 16 except for employing 1,2-di(3-tolyloxy)ethane instead of N-(4-tolyl)phenylacetic amide used in Comparative example 16.

### Comparative Example 18

A heat-sensitive recording sheet was finished in the same manner as Comparative example 16 except for employing 4-hydroxybenzyl benzoate instead of 4,4′-isopropylidenediphenol used in Comparative example 16.

### Comparative Example 19

A heat-sensitive recording sheet was finished in the same manner as Comparative example 18 except for employing 1,2-di(3-tolyloxy)ethane instead of N-(4-tolyl)phenylacetic amide used in Comparative example 18.

<Evaluation of Examples and Comparative Examples>

Evaluation 1: Evaluation of Developing Sensitivity (Recording Speed)

The heat-sensitive recording sheets prepared and finished in Examples 1-18 and Comparative examples 1-19 were subjected to printing/developing. This process was performed using a thermal printer from Okura Electric Inc. with an applied voltage of 24 V, a printing cycle of 8 ms and seven-stage pulse widths of 0.7, 0.8, 1.0, 1.2, 1.4, 1.6 and 2.0 ms. Their developing sensitivities were visually compared with each other. The developing sensitivities were evaluated in the following six stages.

0: Extremely bad developing sensitivity, not practical.

1: Considerably bad developing sensitivity, poor practicality.

2: Bad developing sensitivity, just practical for limited use.

3: Somehow practical developing sensitivity.

4: Good developing sensitivity, sufficiently practical.

5: Extremely good developing sensitivity.

Evaluation 2: Evaluation of Heat Resistance (Reduction of the Developing Sensitivity Due to Volatilization of the Sensitizer)

The heat-sensitive recording sheets prepared and finished in Examples 1-18 and Comparative examples 1-19 were left in an electric oven with an inner volume of about 200 liters at 60° C. for 48 hours. Then, they were measured in the same manner as the evaluation 1 and their reduction of developing sensitivities due to heating were evaluated in the following four stages.

2: Extremely noticeable reduction of developing sensitivity.

3: Observable reduction of developing sensitivity.

4: Less reduction of developing sensitivity, no problem in practical.

5: Almost no reduction of developing sensitivity.

Evaluation 3: Evaluation of Natural Developing(Surface Stain under Heating)

The heat-sensitive recording sheets prepared and finished in Examples 1-18 and Comparative examples 1-19 were printed and then left in an electric oven with an inner volume of about 200 liters at 85° C. for 2 hours. Thereafter, they were visually observed to evaluate conditions of surface stain on parts of white paper due to natural developing in the following five stages.

1: Remarkable natural developing, impossible to read printings.

2: Although natural developing is large, printings can be read somehow.

3: Although natural developing is present, printings can be read sufficiently.

4: Although natural developing is slightly present, sufficiently practical.

5: Almost no natural developing, a high-quality print.

Evaluation 4: Evaluation Of Anti-plasticizer (Typical Property of the Record Retentiveness)

Films of polyvinyl chloride for business use containing a plasticizer were employed, two from upside and two from down side, to sandwich the same record as obtained in the evaluation 1. These films were left at 20° C. for 4 hours while receiving a weight of 20 g/cm³ thereon, and then subjected to a comparison with an initial density of printings. Fading of the printings was visually evaluated in the following five stages.

1: All records were lost.

2: Records were lost considerably, remaining prints slightly.

3: Records were lost slightly, remaining prints a little.

4: Records were hardly lost, remaining prints considerably.

5: Records were almost not lost, remaining prints completely.

Evaluation 5: Powdering Phenomenon on Records

The same record as obtained in the evaluation 1 was placed in at room temperature of 25° C. for 3 days to visually evaluate a powdering phenomenon.

: Powdering phenomenon was found.

x: No powdering phenomenon was found.

Table 1 shows results from the evaluations 1-5 on Examples 1-18 and Table 2 shows results from the evaluations 1-5 on Comparative examples 1-19. Among the evaluations on Comparative examples, a mark * is attached on the right side of a property that is inferior to the evaluations on Examples and causes a problem on practicing in the present invention.

TABLE 1

| | Develop- | | Natural | | |
|---|---|---|---|---|---|
| | ing | Heat | develop- | Anti- | Powdering |
| Examples | sensitivity | resistance | ing | plasticizer | phenomenon |
| 1 | 3 | 5 | 5 | 4 | |
| 2 | 4 | 5 | 4 | 3 | |
| 3 | 4 | 5 | 4 | 5 | |
| 4 | 5 | 4 | 4 | 4 | |
| 5 | 5 | 5 | 4 | 4 | |
| 6 | 5 | 5 | 4 | 4 | |
| 7 | 5 | 5 | 4 | 4 | |
| 8 | 5 | 4 | 3 | 3 | |
| 9 | 5 | 5 | 3 | 3 | |
| 10 | 5 | 4 | 4 | 5 | |
| 11 | 5 | 5 | 4 | 5 | |
| 12 | 4 | 5 | 4 | 4 | |
| 13 | 4 | 5 | 4 | 4 | |
| 14 | 4 | 5 | 4 | 4 | |
| 15 | 4 | 5 | 3 | 4 | |
| 16 | 4 | 5 | 3 | 4 | |
| 17 | 5 | 4 | 3 | 4 | |
| 18 | 5 | 4 | 3 | 4 | |

TABLE 2

| Com- | Develop- | | Natural | | |
|---|---|---|---|---|---|
| parative | ing | Heat | develop- | Anti- | Powdering |
| examples | sensitivity | resistance | ing | plasticizer | phenomenon |
| 1 | 2* | 2* | 3 | 4 | |
| 2 | 2* | 3 | 3 | 4 | |
| 3 | 2* | 3 | 3 | 4 | |
| 4 | 2* | 5 | 3 | 4 | |
| 5 | 3 | 4 | 5 | 4 | x* |
| 6 | 4 | 4 | 5 | 4 | x* |
| 7 | 3 | 4 | 5 | 4 | x* |
| 8 | 5 | 5 | 2* | 4 | x* |
| 9 | 2* | 5 | 5 | 4 | x* |
| 10 | 5 | 4 | 2* | 4 | x* |
| 11 | 4 | 4 | 3 | 4 | x* |
| 12 | 4 | 5 | 3 | 4 | x* |
| 13 | 4 | 5 | 3 | 4 | x* |
| 14 | 4 | 5 | 3 | 4 | x* |
| 15 | 3 | 2* | 3 | 4 | |
| 16 | 4 | 4 | 3 | 1* | |
| 17 | 5 | 3 | 3 | 1* | |
| 18 | 5 | 4 | 3 | 1* | |
| 19 | 5 | 3 | 3 | 1* | |

As obvious from the evaluated results indicated on Table 1 and table 2, the heat-sensitive recording sheet according to the present invention, which comprises a developer with a main component of a phenolic compound that contains a sulfonyl group in a molecule, and a sensitizer with a main component of an amide compound represented by N-(4-tolyl)phenylacetic amide, gives excellent evaluations having a balance on plural properties such as the developing sensitivity, heat resistance, natural developing, anti-plasticizer and powdering phenomenon. In addition, it is greatly significant to apply the conventional 4,4′-dihydroxydiphenylsulfon which is inexpensive but is hardly employed for a developer because of its high melting point (248° C.), to the heat-sensitive recording sheet, resulting in an effect of good record retentiveness.

What is claimed is:

1. A heat-sensitive recording sheet which comprises an electron donative leuco dye, an acidic developer for developing said dye, and a sensitizer, wherein said acidic developer has a main component of a phenolic compound containing a sulfonyl group in a molecule, and said sensitizer comprises an amide compound, N-(4-tolyl)-phenylacetic amide.

2. A heat-sensitive recording sheet which comprises an electron donative leuco dye, an acidic developer for developing said dye, and a sensitizer, wherein said acidic developer has a main component of a phenolic compound containing a sulfonyl group in a molecule, and said sensitizer contains a mixture of at least two amide compounds selected from the group consisting of N-cyclohexylphenylacetic amide, N -phenylphenylacetic amide, N-(2-tolyl)phenylacetic amide, N -(4-tolyl)phenylacetic amide, N-phenylphenoxyacetic amide, N-(4-tolyl)phenoxyacetic amide, N-phenyl-(4-tolyloxy)acetic amide and N-(4-tolyl)-(4-tolyloxy)acetic amide.

3. A heat-sensitive recording sheet which comprises an electron donative leuco dye, an acidic developer for developing said dye, and a sensitizer, wherein said acidic developer has a main component of a phenolic compound containing a sulfonyl group in a molecule, and said sensitizer contains a mixture of at least one amide compound selected from the group consisting of N-cyclohexylphenylacetic amide, N -phenylphenylacetic amide, N-(2-tolyl)phenylacetic amide, N -(4-tolyl)phenylacetic amide, N-phenylphenoxyacetic amide, N-(4-tolyl)phenoxyacetic amide, N-phenyl-(4-tolyloxy)acetic amide, and N-(4-tolyl)-(4-tolyloxy)acetic amide and at least one ether or ester compound selected from the group consisting of 1,2-diphenoxyethane, 1,2-di(3-tolyloxy)ethane, 2-benzyloxy naphthalene and di(4-methylbenzyl)oxalate.

4. The heat-sensitive recording sheet according to any one of claims 1-3, wherein said sulfonyl group-containing phenolic compound contains at least one selected from the group consisting of 4,4′-dihydroxydiphenylsulfon, 4-hydroxy-4′-isopropoxydiphenylsulfon and 2,4-diphenylsulfonyl-5-methyl phenol.

5. The heat-sensitive recording sheet according to claim 4, wherein said sulfonyl group-containing phenolic compound comprises 4,4′-dihydroxydiphenylsulfon.
